(19) United States
(12) Patent Application Publication
(10) Pub. No.: US 2009/0090213 A1
(43) Pub. Date: Apr. 9, 2009

(54) STEERING WHEEL COVER

(76) Inventor: Yuan-Yuan HUANG, Tainan Hsien (TW)

Correspondence Address: SHERIDAN ROSS PC, 1560 BROADWAY, SUITE 1200, DENVER, CO, 80202, US

(21) Appl. No.: 11/866,512

(22) Filed: Oct. 3, 2007

(51) Int. Cl. B62D 1/06

(52) U.S. Cl. 74/558

(57) ABSTRACT

A steering wheel cover includes: an inner sleeve; an outer cover provided with a plurality of intersected stitching lines so as to form a plurality of recesses at intersections of the intersected stitching lines and a plurality of convex portions among the recesses, each of the convex portions protruding in a direction away from the inner sleeve; and a plurality of shape-retaining pieces, each of which is disposed securely in a respective one of the recesses in the outer cover and each of which engages the outer cover in such a manner so as to retain the shape of the respective one of the recesses.

### BACKGROUND OF THE INVENTION

1. Field of the Invention

This invention relates to a steering wheel cover, more particularly to a steering wheel cover formed with a plurality of recesses and convex portions.

2. Description of the Related Art

A steering wheel cover is used to cover a steering wheel for providing friction during operation of the steering wheel. Conventional steering wheel covers are mainly made from a rubber material or leather. The leather-formed steering wheel cover may have a natural appearance and good feeling in touch, but it has a smooth surface and provides insufficient friction during operation of the steering wheel.

### SUMMARY OF THE INVENTION

Therefore, the object of the present invention is to provide a steering wheel cover that can overcome the aforesaid drawback associated with the prior art.

According to the present invention, a steering wheel cover comprises: an inner sleeve adapted to be sleeved on a steering wheel and having an outer surface; an outer cover attached and conforming to the outer surface of the inner sleeve and provided with a plurality of intersected stitching lines so as to form a plurality of recesses at intersections of the intersected stitching lines and a plurality of convex portions among the recesses, each of the convex portions protruding in a direction away from the inner sleeve; and a plurality of shape-retaining pieces, each of which is disposed securely in a respective one of the recesses in the outer cover and each of which engages the outer cover in such a manner so as to retain the shape of respective one of the recesses.

### BRIEF DESCRIPTION OF THE DRAWINGS

In drawings which illustrate an embodiment of the invention,

FIG. 1 is a perspective view of the preferred embodiment of a steering wheel cover according to this invention;

FIG. 2 is a fragmentary exploded perspective view of the preferred embodiment; and

FIG. 3 is a fragmentary partly sectional view of the preferred embodiment.

### DETAILED DESCRIPTION OF THE PREFERRED EMBODIMENT

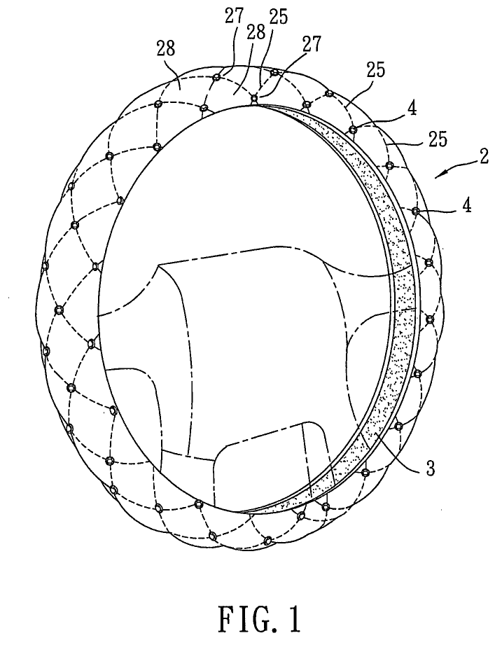

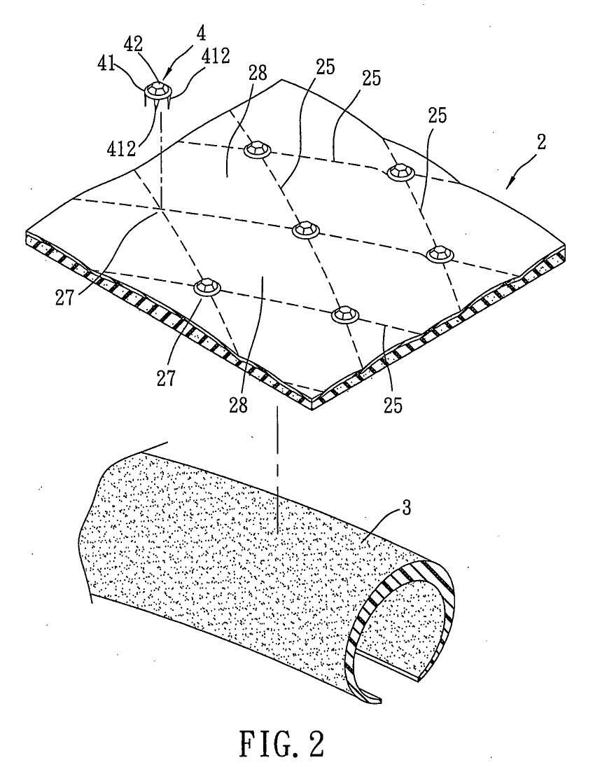

FIGS. 1 to 3 illustrate the preferred embodiment of a steering wheel cover according to this invention.

The steering wheel cover includes: an inner sleeve 3 adapted to be sleeved on a steering wheel (not shown); an outer cover 2 attached and conforming to an outer surface of the inner sleeve 3 and provided with a plurality of intersected stitching lines 25 so as to form a plurality of recesses 27 at intersections of the intersected stitching lines 25 and a plurality of convex portions 28 among the recesses 27, each of the convex portions 28 protruding in a direction away from the inner sleeve 3; and a plurality of shape-retaining pieces 4, each of which is disposed securely in a respective one of the recesses 27 in the outer cover 2 and each of which engages the outer cover 2 in such a manner so as to retain the shape of the respective one of the recesses 27.

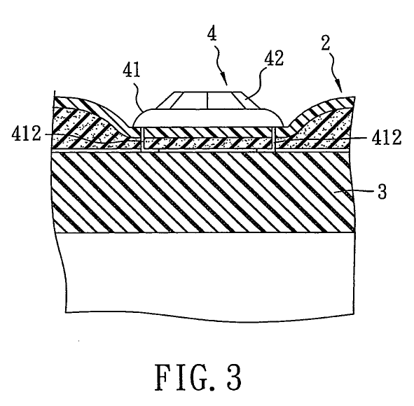

In this embodiment, each of the shape-retaining pieces 4 has a mounting seat 41 formed with a plurality of pins 412, each piercing into the outer cover 2 and bent into an L-shape so as to be tightly fixed to the outer cover 2 to retain the shape of the respective recess 27 (see FIG. 3). A decorative member 42 is mounted on the mounting seat 41 for enhancing the aesthetic effect.

Preferably, the outer cover 2 is made from leather.

By forming the recesses 27 and the convex portions 28 on the outer cover 2, the aforesaid drawback associated with the conventional steering wheel cover can be eliminated.

With the invention thus explained, it is apparent that various modifications and variations can be made without departing from the spirit of the present invention. It is therefore intended that the invention be limited only as recited in the appended claims.

What is claimed is:

1. A steering wheel cover comprising:
an inner sleeve adapted to be sleeved on a steering wheel and having an outer surface;
an outer cover attached and conforming to said outer surface of said inner sleeve and provided with a plurality of intersected stitching lines so as to form a plurality of recesses at intersections of said intersected stitching lines and a plurality of convex portions among said recesses, each of said convex portions protruding in a direction away from said inner sleeve; and
a plurality of shape-retaining pieces, each of which is disposed securely in a respective one of said recesses in said outer cover and each of which engages said outer cover in such a manner so as to retain the shape of the respective one of said recesses.

2. The steering wheel cover of claim 1, wherein each of said shape-retaining pieces has a mounting seat formed with a plurality of pins for piercing into said outer cover, and a decorative member mounted on said mounting seat.

3. The steering wheel cover of claim 1, wherein said outer cover is made from leather.
